(19) United States
(12) Patent Application Publication
(10) Pub. No.: US 2008/0266307 A1
(43) Pub. Date: Oct. 30, 2008

(54) Method and System for Enhancing the Sharpness of a Video Signal

(75) Inventors: Paul Michiel Hofman, Eindhoven (NL); Jeroen Arnoldus Paulus Tegenbosch, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,169

(22) PCT Filed: May 17, 2005
(86) PCT No.: PCT/IB05/51590

§ 371 Date: Nov. 16, 2006

(30) Foreign Application Priority Data
May 25, 2004 (EP) 04300301.1

(51) Int. Cl. G09G 5/00

(52) U.S. Cl. 345/581

(57) ABSTRACT

The invention relates to a method and a system for modifying input images (101) for generating output images (102), said method comprising the steps of: splitting (103) said input images (101) into coarse images (104) and fine images (105), enhancing (106) the sharpness of said coarse images (104) for generating intermediate sharpness-enhanced images (107), combining (108) said intermediate sharpness-enhanced images (107) and said fine images (105) for generating said output images (102).

### FIELD OF THE INVENTION

The invention relates to a method and a system for enhancing the sharpness of a video signal.

The invention may be used, for example, in the field of video processing.

### BACKGROUND OF THE INVENTION

Improving image quality has become an important issue in video products such as television sets. Image quality is in particular perceptually improved if the sharpness of the input images, which define said video, is increased. There are known solutions for increasing the sharpness of a video signal.

A first solution consists in enhancing the sharpness of the input images by means of a filter applied to all successive images. Since input images may also contain a noise component, for example, analog white noise or digital artefacts resulting from previous block-encoding and decoding operations, the noise component is also enhanced, to the detriment of the overall image quality of the resulting output images.

A second solution consists not only in enhancing the sharpness of the input images by means of a filter applied to all successive images, but also in adapting the level of enhancement in accordance with the level of the noise component detected in said input images. If the noise component has a low level, the sharpness of the resulting output images is highly increased. In contrast, if the noise component has a high level, the filter is switched off (or tuned down) for avoiding enhancement of the noise component, but in that case the sharpness of the resulting output images is unfortunately close to that of the input images. This second method is thus limitative in that it is not efficient when dealing with too noisy input images.

### OBJECT AND SUMMARY OF THE INVENTION

It is an object of the invention to propose a method of enhancing the sharpness of a video signal, which is robust to noise.

To this end, the method according to the invention proposes modification of input images for generating output images. Said method comprises the steps of:
splitting said input images into coarse images and fine images,
enhancing the sharpness of said coarse images for generating intermediate sharpness-enhanced images,
combining said intermediate sharpness-enhanced images and said fine images for generating said output images.

This method is based on the assumption that the input images are defined as the sum of a signal component and a noise component, the signal component having a low frequency spectrum and the noise component having a high frequency spectrum. The part of the frequency spectrum to be enhanced in the input images is thus situated at low frequencies, while the part of the frequency spectrum not to be enhanced in the input images is situated at high frequencies.

The step of splitting allows generation of two types of images: coarse images having a low frequency spectrum and fine images having a high frequency spectrum. This splitting allows selective enhancement of the coarse images which contain mainly a signal component. Performing a sharpness enhancement on images having a low frequency spectrum leads to better results than on images having a high frequency spectrum.

This method is robust to noise because, irrespective of the noise level in the input images, the noise component is not enhanced in the resulting output images. After combining, the resulting output images still have a noise component close to that of the input images, but the overall image quality is improved because the sharpness of the signal component has been enhanced.

Said step of splitting preferably comprises the steps of:
low-pass filtering said input images for generating said coarse images,
subtracting said coarse images from said input images for generating said fine images.

Use of the subtracting step allows a perfect split of the input images without losing any data information. Moreover, this leads to a cost-effective solution.

The step of low-pass filtering is preferably adaptive to a first noise signal derived from said input images.

The limit between the low-frequency spectrum corresponding to the signal component and the high-frequency spectrum corresponding to the noise component is defined adaptively and accurately. This allows applying the sharpness enhancement on the overall spectrum of the signal component independently of the noise level in the input images, resulting in output images with an increased sharpness.

The step of enhancing is preferably adaptive to a second noise signal derived from said input images.

This allows adaptation of the sharpness enhancement to the noise level of the input images, for example, in using a more aggressive sharpness enhancement when the noise level is high, and in using a lighter sharpness enhancement when the noise level is low.

The step of low-pass filtering and the step of enhancing are preferably adaptive to noise signals derived from said input images.

This allows applying the sharpness enhancement on the overall frequency spectrum of the signal component, independently of the noise level in the input images, and adapting the sharpness enhancement to the noise level of the input images, resulting in output images with an increased sharpness.

It is also an object of the invention to propose a system for enhancing the sharpness of a video signal, which system is robust to noise and comprises processing means for implementing the various steps of the method according to the invention.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner.

FIG. 1 depicts the general arrangement of the method according to the invention,

FIG. 2 depicts a detailed arrangement of the method according to the invention,

FIG. 3 illustrates, by way of an example, the sharpness enhancement of an image,

FIG. 4 depicts a preferred arrangement of the method according to the invention.

### DETAILED DESCRIPTION OF THE INVENTION

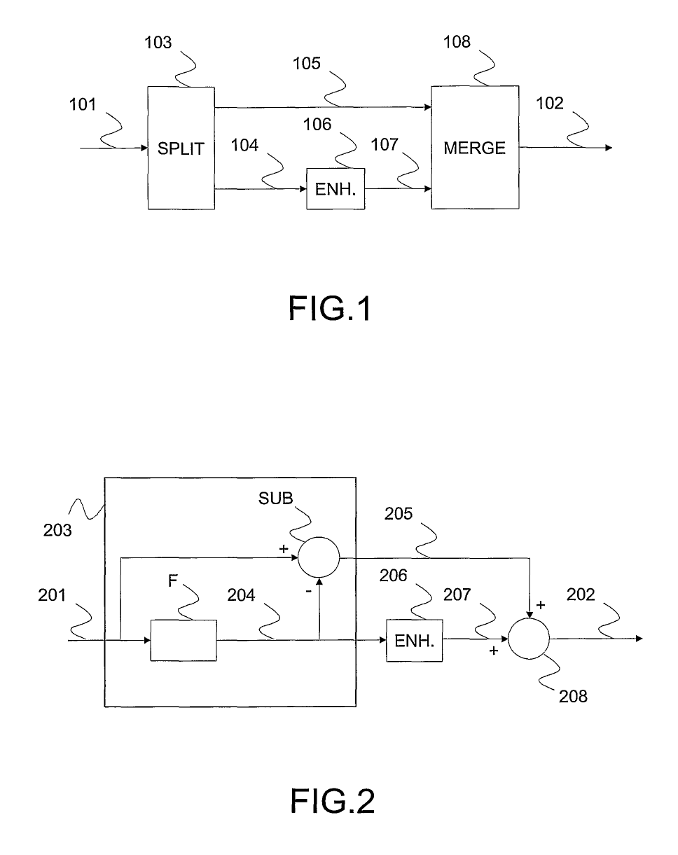

FIG. 1 depicts the general arrangement of the method according to the invention of modifying input images 101 for generating output images 102.

This method comprises a step 103 of splitting said input images 101 into coarse images 104 and fine images 105. The frequency spectrum of the coarse images 104 corresponds to the low frequency spectrum of the input images 101, while the frequency spectrum of the fine images 105 corresponds to the high frequency spectrum of the input images 101.

This method also comprises a step 106 of enhancing the sharpness of said coarse images 104 for generating intermediate sharpness-enhanced images 107.

This method also comprises a step 108 of combining said intermediate sharpness-enhanced images 107 and said fine images 105 for generating said output images 102. This step 108 allows reconstruction of the output images.

FIG. 2 depicts a detailed arrangement, based on FIG. 1, of the method according to the invention of modifying input images 201 for generating output images 202. The step 203 of splitting comprises a step F of low-pass filtering said input images 201 (via a convolution operation) for generating said coarse images 204.

In a first example, the step F of low-pass filtering implements a Gaussian filter intended to be applied on the pixels composing said coarse images 204. This linear filter may be defined by the following kernels k1 or k2:

$$k 1 = [ \begin{matrix}0.0 & 0.0 & 0.0 & 0.0 & 0.0 \\ 0.0 & 0.0751 & 0.1238 & 0.0751 & 0.0 \\ 0.0 & 0.1238 & 0.2042 & 0.1238 & 0.0 \\ 0.0 & 0.0751 & 0.1238 & 0.0751 & 0.0 \\ 0.0 & 0.0 & 0.0 & 0.0 & 0.0\end{matrix} ]$$

$$k 2 = [ \begin{matrix}0.0030 & 0.0133 & 0.0219 & 0.0133 & 0.0030 \\ 0.0133 & 0.0596 & 0.0983 & 0.0596 & 0.0133 \\ 0.0219 & 0.0983 & 0.1621 & 0.0983 & 0.0219 \\ 0.0133 & 0.0596 & 0.0983 & 0.0596 & 0.0133 \\ 0.0030 & 0.0133 & 0.0219 & 0.0133 & 0.0030\end{matrix} ]$$

Alternatively, the step F of low-pass filtering may implement:
a non-linear FIR filter (e.g. having a kernel dependent on the pixel location in the images, or a kernel applied on the edges of blocks of pixels),
an order statistical filter (such as a median filter, a rank order filter or a morphological filter): it is based on sorting (or ranking) a number of pixels values and selecting given sorted pixel values based on its rank.

The step 103 of splitting also comprises a step SUB of subtracting said coarse images 204 from said input images 201 for generating said fine images 205. The subtraction is done between a pixel of an input image 201 and a pixel of a coarse image 204, which pixels have the same coordinates in the images, while the subtraction is repeated for all pixels of both images.

The step 206 of enhancing the sharpness of said coarse images 204 may consist in a non-linear processing (described in the following section) performed on pixels of the lines and/or the columns of the coarse images 204. The sharpness may be seen as a level transition between two data areas, which are flat or slowly varying. The level transitions to be enhanced are detected, for example, by applying a gradient filter to the coarse images 204, and by detecting areas that have the highest levels in these resultant filtered images.

The step of combining comprises a step 208 of adding said intermediate sharpness-enhanced images 207 to said fine images 205, for generating said output images 202.

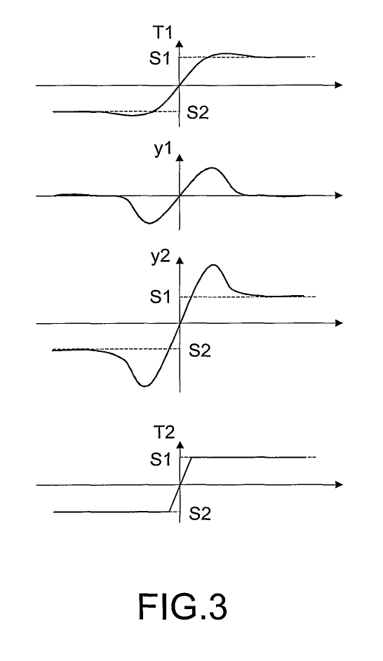

FIG. 3 illustrates, by way of an example, a transition signal T1 of a level transition along the line of a coarse image 204. This transition signal comprises a first flat area having a level S1 and a second flat area having a level S2. To enhance the transition signal T1, a set of successive processing operations may be performed.

A first processing operation consists in convoluting the transition signal T1 with the kernel of a derivative filter DF, for generating a first intermediate signal y1 having overshoots either at the beginning or at the end of the transition, as follows:

y1=T1\textcircled{x}DF (1)

wherein \textcircled{x} represents the convolution operation,
DF is a filter kernel, for example, of the form [−0.25 0.5 −0.25].

A second processing operation consists in adding the transition signal T1 to a fraction/multiple of said first intermediate signal y1, for generating a second intermediate signal y2, as follows:

y2=T1+α*y1 (2)

wherein α is a coefficient, for example, equal to 1.

A third processing operation consists in suppressing the remaining overshoots in the second intermediate signal y2, for generating the enhanced transition signal T2, as follows:

T2=med(S1,S2,y2) (3)

wherein med(S1, S2, y2) represents the median operation among data samples of signals
S1, S2 and y2.

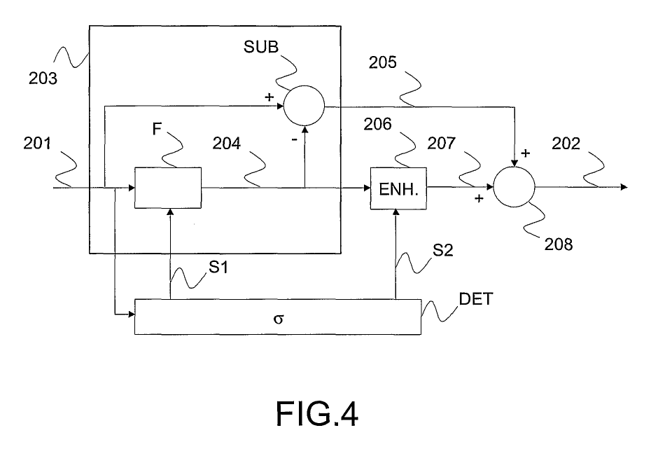

FIG. 4 depicts a preferred arrangement, based on FIG. 2, of the method according to the invention of modifying input images 201 for generating output images 202.

This arrangement differs from FIG. 2 in that the step F of low-pass filtering is adaptive to a noise signal S1 derived from said input images 201. This allows generating coarse images 204 corresponding to a signal component, independently of the noise level comprised in the input images 201. For example, the filter kernel may change in accordance with the noise level carried by signal S1.

The higher the noise level σ in input images 201, the lower the cut-off frequency of the low-pass filter must be. It may be decided that the first kernel k1 defined previously is used for a low noise level σ1, while the second kernel k2 defined previously is used for a higher noise level σ2.

Alternatively, the filter coefficients may be adaptive to the noise level σ detected in input images 201, in defining each coefficient of the kernel k by a function (f1, f2, . . . ) depending on the noise level σ, as follows:

$$k = [ \begin{matrix}f 1 ( σ ) & f 2 ( σ ) & f 3 ( σ ) \\ f 4 ( σ ) & f 5 ( σ ) & f 6 ( σ ) \\ f 7 ( σ ) & f 8 ( σ ) & f 9 ( σ )\end{matrix} ] \qquad ( 4 )$$

The functions (f1, f2, . . . f9) are derived from, for example, a basic experiment.

This arrangement also differs from FIG. 2 in that the step 206 of enhancing is also adaptive to a noise signal S2 derived from said input images 201. This allows generating intermediate enhanced images 207 having an optimized sharpness, independently of the noise level comprised in the input images 201. For example, the relation (2) may be modified in introducing a coefficient α depending on the noise level σ, as follows:

y2=T1+α(σ)*y1 (5)

The higher the noise level σ in input images 201, the larger α must be. For example, a linear relation between α and σ may be established.

It is noted that the step F of filtering and the step 206 of enhancing are not necessarily adaptive to the noise level σ simultaneously, and that the adaptation to the noise level σ may concern only one of these two steps.

The noise level σ in input images 201 is measured by a step DET. This step generates a first and a second signal S1 and S2 (which may be the same) proportional to said noise level σ. For example, the noise level σ may be derived from any algorithm known to a skilled person. For example, such signals may reflect an analog noise measure (e.g. in using a frequency spectrum-based algorithm), and/or a digital noise measure (e.g. in using a blocking-effect detector measuring the activity at the periphery of blocks of 8*8 pixels or 16*16 pixels).

The method according to the invention may be implemented in a system for modifying input images 101 so as to generate output images 102. This system comprises processing means for implementing the various steps of the method according to the invention previously described. In particular, this system comprises:
means 103 for splitting said input images 101 into coarse images 104 and fine images 105. The means 103 may comprise a low-pass filter intended to receive said input images 101 for generating said coarse images 104, and a subtracting means SUB for subtracting said coarse images 104 from said input images 101 so as to generate said fine images 105. The means 103 correspond, for example, to code instructions (i.e. a computer program) stored in a memory and executed by a signal processor. Advantageously, the low-pass filter coefficients are adapted to a signal S1 reflecting a noise level derived from said input images 101.
means 106 for enhancing the sharpness of said coarse images 104 for generating intermediate sharpness-enhanced images 107. The means 106 correspond, for example, to code instructions (i.e. a computer program) for coding the sharpness enhancement algorithm described with reference to FIG. 3, said code instructions being stored in a memory and executed by a signal processor. Advantageously, the enhancement is adapted to a signal S2 reflecting a noise level derived from said input images 101.
a step 108 of combining said intermediate sharpness-enhanced images 107 and said fine images 105 for generating said output images 102. The means 108 correspond, for example, to code instructions (i.e. a computer program) stored in a memory and executed by a signal processor.

This system may be embodied as an electronic card and implemented in a video apparatus (e.g. a television set, video broadcast equipment, etc.), said video apparatus being intended to receive said input images 101, and to display or broadcast said output images 102 on a display or on a communication channel, respectively.

The invention also relates to a computer program comprising code instructions for implementing the various steps of the method according to the invention.

It is to be noted that the use of the verb “comprise” and its conjugations does not exclude the presence of elements or steps other than those stated in the claims.

1. A method of modifying input images (101) for generating output images (102), said method comprising the steps of:
splitting (103) said input images (101) into coarse images (104) and fine images (105),
enhancing (106) the sharpness of said coarse images (104) for generating intermediate sharpness-enhanced images (107),
combining (108) said intermediate sharpness-enhanced images (107) and said fine images (105) for generating said output images (102).

2. A method as claimed in claim 1, wherein said step (103) of splitting comprises the steps of:
low-pass filtering (F) said input images (101) for generating said coarse images (104),
subtracting (SUB) said coarse images (104) from said input images (101) for generating said fine images (105).

3. A method as claimed in claim 2, wherein said step (F) of low-pass filtering is adaptive to a first noise signal (S1) derived from said input images (101).

4. A method as claimed in claim 2, wherein said step (106) of enhancing is adaptive to a second noise signal (S2) derived from said input images (101).

5. A method as claimed in claim 2, wherein said step (F) of low-pass filtering and said step (106) of enhancing are adaptive to noise signals (S1, S2) derived from said input images (101).

6. A method as claimed in claim 3, further comprising a step (DET) of measuring a noise level (σ) in said input images (101), for generating said noise signals (S1, S2).

7. A method as claimed in claim 1, wherein said step (108) of combining comprises a step of adding said intermediate sharpness-enhanced images (107) to said fine images (105) for generating said output images (102).

8. A system for modifying input images (101) so as to generate output images (102), said system comprising:
means (103) for splitting said input images (101) into coarse images (104) and fine images (105),
means (106) for enhancing the sharpness of said coarse images (104) so as to generate intermediate sharpness-enhanced images (107),
means (108) for combining said intermediate sharpness-enhanced images (107) and said fine images (105) so as to generate said output images (102).

9. A system as claimed in claim 8, wherein said means (103) for splitting comprises:
a low-pass filter (F) for filtering said input images (101) so as to generate said coarse images (104),
means (SUB) for subtracting said coarse images (104) from said input images (101) so as to generate said fine images (105).

10. A system as claimed in claim 9, wherein said low-pass filter (F) and/or said means (106) for enhancing are adaptive to noise signals (S1, S2) which are derived from said input images (101).

11. A video apparatus for modifying input images (101) so as to generate output images (102), said video apparatus comprising:
means (103) for splitting said input images (101) into coarse images (104) and fine images (105),
means (106) for enhancing the sharpness of said coarse images (104) so as to generate intermediate sharpness-enhanced images (107),
means (108) for combining said intermediate sharpness-enhanced images (107) and said fine images (105) so as to generate said output images (102).

12. A computer program comprising code instructions for implementing the various steps of the method as claimed in claim 1.
